(19) United States
(12) Patent Application Publication
(10) Pub. No.: US 2009/0033794 A1
(43) Pub. Date: Feb. 5, 2009

(54) VIDEO SIGNAL PROCESSING APPARATUS AND METHOD, AND TELEVISION BROADCAST RECEIVER

(75) Inventor: Toshiyuki Arisaka, Annaka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/181,664

(22) Filed: Jul. 29, 2008

(30) Foreign Application Priority Data
Jul. 31, 2007 (JP) 2007-199921

(51) Int. Cl. H04N 5/445; H04N 9/65

(52) U.S. Cl. 348/563; 348/642; 348/728; 348/E05.099; 348/E09.045

(57) ABSTRACT

According to one embodiment, a video signal processing apparatus includes a signal processor. The signal processor receives a digital video signal transmitted in a format conforming to a specific digital signal transmission standard to perform signal processing for video display. The signal processor selectively switches signal processing corresponding to a standard colorspace and signal processing exceeding the standard colorspace. A message is displayed such that a received digital video signal corresponds to a colorspace exceeding the standard colorspace, and the signal processor is set to a function of performing signal processing corresponding to the standard colorspace.

### CROSS-REFERENCE TO RELATED APPLICATIONS

This application is based upon and claims the benefit of priority from Japanese Patent Application No. 2007-199921, filed Jul. 31, 2007, the entire contents of which are incorporated herein by reference.

### BACKGROUND

1. Field

One embodiment of the invention relates to video signal processing apparatus and method and a television broadcast receiver, which perform display signal processing with respect to a digital video signal acquired externally in accordance with a predetermined digital interface standard.

2. Description of the Related Art

As is already known, the Digital Visual Interface (DVI) standard has come into wide use as the standard for transmitting a digital video signal. Recently, the High-Definition Multimedia Interface (HDMI) standard has been employed as a digital signal transmission standard that further improves on the foregoing DVI standard.

The foregoing HDMI standard includes the following various stipulations, which are not defined in the DVI standard. For example, a digital audio signal is multiplexed for a blanking interval of a digital video signal to perform audio transmission. The digital video signal is transmitted in an RGB signal format. In addition, the digital video signal is transmitted in a YCbCr signal formal or in a higher quality YPbPr format. Connection is possible using a compact HDMI connector similar to a Universal Serial Bus (USB) connector.

In particular, according to the HDMI standard, the following digital video signals are defined as being transmittable. One is a digital video signal conforming to a standard colorspace setting. Another is a digital video signal conforming to the so-called xvYCC colorspace setting exceeding the standard.

For this reason, the following proposal is now made. Namely, the following functions are built in an apparatus receiving a digital video signal. transmitted according the HDMI standard. One is a function of performing signal processing with respect to a standard colorspace-enabled digital video signal to display video. Another is a function of performing signal processing with respect to an xvYCC-enabled digital video signal to display video. In this way, the user selectively switches the foregoing two functions.

However, a receiver adaptable to both standard colorspace-enabled digital video signal and xvYCC-enabled digital video signal is developing. Thus, various improvements are required over the details.

For example, the following support system development is deeply desired. Specifically, the user easily knows whether or not the present selected function of the receiver is adaptable to a colorspace of the received digital video signal. In this way, the user easily switches the receiver so that a function adaptable to the colorspace of the received digital video signal is correctly selected.

Jpn. Pat. Appln. KOKAI Publication No. 2007-096604 discloses the following video receiver and configuration. The video receiver outputs reception specification data for receiving a signal adaptable to itself to a transmitter, which selectively transmits the same content signal in a plurality of signal formats. According to the configuration, the receiver can transmit either of first reception specification data designated as default and second reception specification data designating a predetermined signal format to the transmitter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram to explain the configuration a video processing system of a television broadcast receiver according to one embodiment of the invention;

FIG. 2 is a view to explain one example of a HDMI state indicator displayed on a display screen of the television broadcast receiver in the embodiment; and

FIG. 3 is a flowchart to explain the principal processing operation of the television broadcast receiver in the embodiment.

### DETAILED DESCRIPTION

Various embodiments according to the invention will be described hereinafter with reference to the accompanying drawings. In general, according to one embodiment of the invention, a video signal processing apparatus includes a signal processor. The signal processor receives a digital video signal transmitted in a format conforming to a specific digital signal transmission standard to perform signal processing for video display. The signal processor selectively switches signal processing corresponding to a standard colorspace and signal processing exceeding the standard colorspace. A message is displayed such that a received digital video signal corresponds to a colorspace exceeding the standard colorspace, and the signal processor is set to a function of performing signal processing corresponding to the standard colorspace.

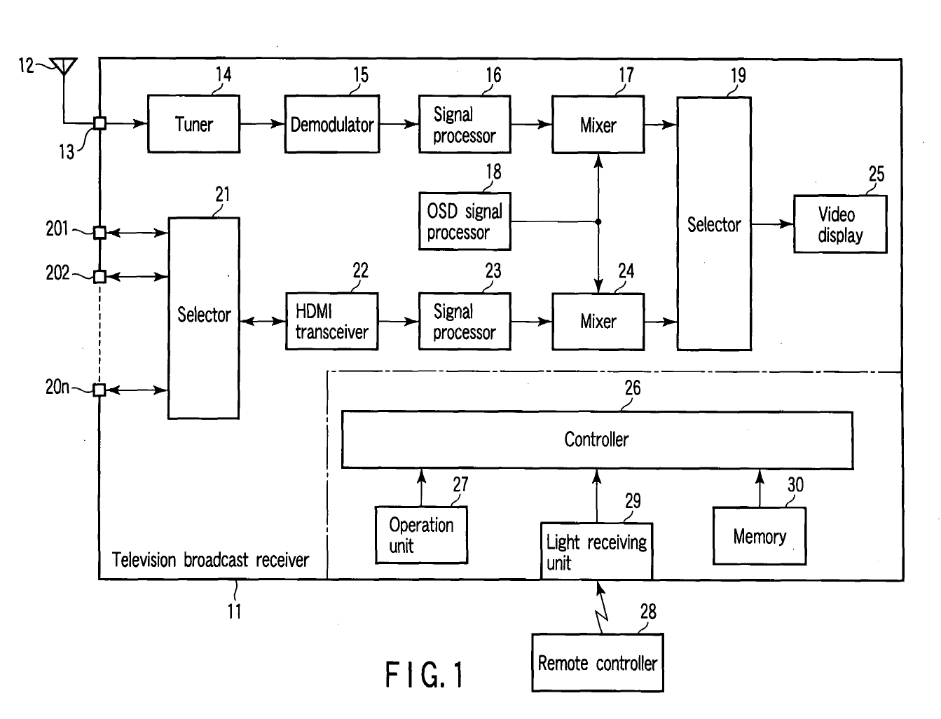

One embodiment of the present invention will be hereinafter described with reference to the accompanying drawings. FIG. 1 is a block diagram to explain the configuration a video processing system of a television broadcast receiver 11 described in this embodiment. Namely, a television broadcast signal received by an antenna 12 is supplied to a tuner 14 via an input terminal, and thereby, a desired channel broadcast signal is tuned.

The broadcast signal tuned by the tuner 14 is demodulated by a demodulator 15, and then, subjected to predetermined signal processing by a signal processor .16, and thereby, restored to an analog video signal. Thereafter, the analog video signal output from the signal processor 16 is mixed with an on-screen display (OSD) signal output from an OSD signal processor 18, and then, supplied to one input terminal of a selector 19.

The television broadcast receiver 11 includes a plurality of HDMI terminals 201, 202, . . . , 20n. These HDMI terminals 201 to 20n are each connected with an external apparatus such as a digital versatile disk (DVD) player. Each of the HDMI terminals 201 to 20n is supplied with a digital video signal converted to a format conforming to the HDMI standard from the connected external apparatus.

Digital video signals supplied to the HDMI terminals 201 to 20n are supplied to a selector 21. The selector 21 selects any one digital video signal from the inputted digital video signals, and thereafter, output it. The digital video signal selected and output by the selector 21 is supplied to an HDMI transceiver 22 so that it is restored to a digital video signal before converted to a format conforming to the HDMI standard.

The digital video signal output from the HDMI transceiver 22 is supplied to a signal processor 23 to be subjected to predetermined signal processing, and thereby, restored to an analog video signal. Thereafter, the analog video signal output from the signal processor 23 is mixed with an OSD signal output from the OSD signal processor 18 by a mixer 24, and then, supplied to the other terminal of the selector 19.

The selector 19 selects any one of analog video signals output from the mixers 17 and 24, and then, output it. The analog video signal selected by the selector 19 is supplied to a video display unit 25 comprising a flat crystal liquid display to display the video.

The HDMI transceiver 22 selects and receives extended display identification (EDID) data output from each external apparatus and supplied to the HDMI terminals 201 to 20n using the selector 21, and outputs a response signal corresponding the data. The response signal output from the HDMI transceiver 22 is transmitted to the corresponding external apparatus via the selector 21.

A controller 26 integrally controls all operations including the foregoing various reception operations of the television broadcast receiver 11. The controller 26 has a built-in central processing unit (CPU). The controller 26 receives operation information from a operation unit 27 or operation information received to a light receiving unit 29 sent from a remote controller 28. The controller 26 controls various components so that the foregoing operation content is reflected.

In this case, the controller 26 uses a memory 30. The memory 30 mainly has the following memories. One is a read-only memory (ROM) storing control programs executed by the CPU of the controller 26. Another is a random access memory (RAM) for providing a work area for the CPU. Another is a non-volatile memory for storing various setting information and control information.

As described before, according to the HDMI standard, an xvYCC-enabled colorspace (wide) digital video signal exceeding the standard is transmittable in addition to a standard colorspace-enabled digital video signal.

The signal processor 23 of the foregoing television broadcast receiver 11 has the following functions. One is a function of performing standard colorspace-enabled signal processing with respect to the digital signal supplied from the HDMI transceiver 22. Another is a function of performing xvYCC-enabled signal processing. The user selectively switches and sets the foregoing two functions using the operation unit 27 or the remote controller 28.

The controller 26 of the television broadcast receiver 11 displays the following correspondence relationship on the video display unit 25 using the OSD signal. It is the correspondence relationship between a self-setting state showing whether the present function is set to any function and the colorspace of the digital video signal now received by the HDMI transceiver 22.

Specifically, the controller 26 displays the following setting case on the video display unit 25 using the OSD signal. Specifically, setting is made so that a digital video signal transmitted in a format conforming to the HDMI standard from the external apparatus is displayed. In other words, the selector 19 is set to select an analog video signal output from the mixer 24.

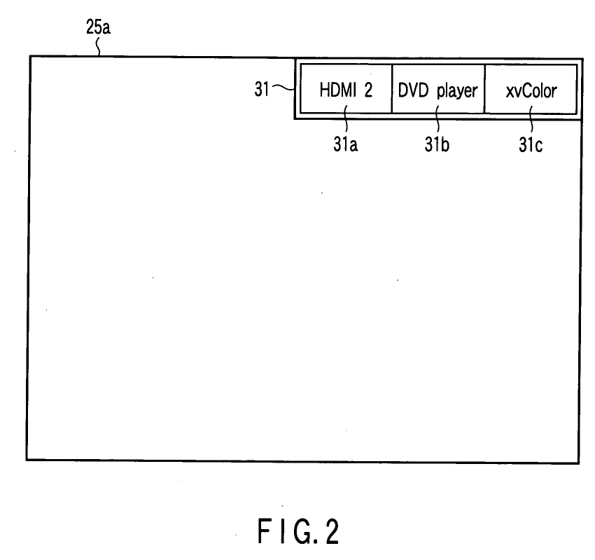

FIG. 2 shows a display screen 25a of the foregoing video display unit 25. If an input video conforming to the HDMI standard is displayed, an HDMI state indicator 31 showing the foregoing effect is displayed on the upper right portion of the display screen 25a of the video display unit 25. The HDMI state indicator 31 is displayed on the display screen 25a of the video display unit 25 in a state of being overlapped with a display video based on an HDMI-enabled video signal.

The HDMI state indicator 31 is provided with an input display area 31a. The input display area 31a shows a digital video signal displayed as a video, that is, HDMI terminals 201 to 20n inputting a digital video signal selected by the selector 21 using numbers 1, 2, . . . , n. The HDMI state indicator 31 is further provided with an apparatus display area 31b. The apparatus display area 31b shows a digital video signal displayed as a video, that is, an external apparatus name outputting a digital video signal selected by the selector 21.

The HDMI state indicator 31 is further provided with a colorspace display area 31c. The colorspace display area 31c shows a digital video signal displayed as a video, that is, a colorspace of a digital video signal selected by the selector 21. If a digital video signal selected by the selector 21 corresponds to a standard colorspace, the colorspace display area 31c is in a non-display state having nothing to be displayed.

A digital video signal selected by the selector 21 corresponds to an xvYCC-enabled colorspace, and the signal processor 23 is set to a function of performing xvYCC-enabled signal processing. In this case, the colorspace display area 31c displays a character string “xvColor” with a standard brightness.

Moreover, a digital video signal selected by the selector 21 corresponds to an xvYCC-enabled colorspace, and the signal processor 23 is set to a function of performing standard colorspace-enabled signal processing. In this case, the colorspace display area 31c displays a character string “xvColor” with brightness darker than a standard brightness.

Numbers 1 to n of the HDMI terminals 201 to 20n and an external apparatus name are displayed in the input display area 31a and the apparatus display area 31b of the HDMI state indicator 31, respectively. Further, the colorspace display area 31c is in a non-display state. In this case, the user can determine that a digital video signal displayed as a video at present corresponds to a standard colorspace. Thus, the user can switch the signal processor 23 to a function of performing standard colorspace-enabled signal processing.

Moreover, numbers 1 to n of the HDMI terminals 201 to 20n and an external apparatus name are displayed in the input display area 31a and the apparatus display area 31b of the HDMI state indicator 31, respectively. Further, “xvColor” is displayed in the colorspace display area 31c with a standard brightness. In this case, the user can determine that a digital video signal displayed as a video at present corresponds to xvYCC, and the signal processor 23 is set to a function of performing xvYCC-enabled signal processing.

Numbers 1 to n of the HDMI terminals 201 to 20n and an external apparatus name are displayed in the input display area 31a and the apparatus display area 31b of the HDMI state indicator 31, respectively. further, the colorspace display area 31c displays a character string “xvColor” with brightness darker than a standard brightness. In this case, the user can determine that a digital video signal displayed as a video at present corresponds to xvYCC, and the signal processor 23 is set to a function of performing standard colorspace-enabled signal processing.

Specifically, the xvYCC-enabled digital video signal is input; nevertheless, the user can determine that the present signal processing function of the signal processor 23 does not correspond to an input digital video signal, and a video is not displayed in a state of sufficiently performing xvYCC-enabled colorspace display ability. Thus, the user easily makes a determination for switching the signal processor 23 to a function of performing xvYCC-enabled signal processing.

In brief, the controller 26 of the television broadcast receiver 11 displays the correspondence relationship using the display format of the colorspace display area 31c so that the user can easily understand. The correspondence relationship is correspondence of the signal processing function setting state of the signal processor 23 and the colorspace of a digital video signal displayed as a video acquired from an external apparatus.

Thus, the user can easily determine whether or not the correspondence relationship between the signal processing function setting state of the signal processor 23 and the colorspace of a digital video signal displayed as a video acquired from an external apparatus is an optimum state. If the correspondence relationship is not the optimum state, support is possible so that the user can easily switch to colorspace-enabled signal processing of a digital video signal displayed as a video. Therefore, this support enhances operability.

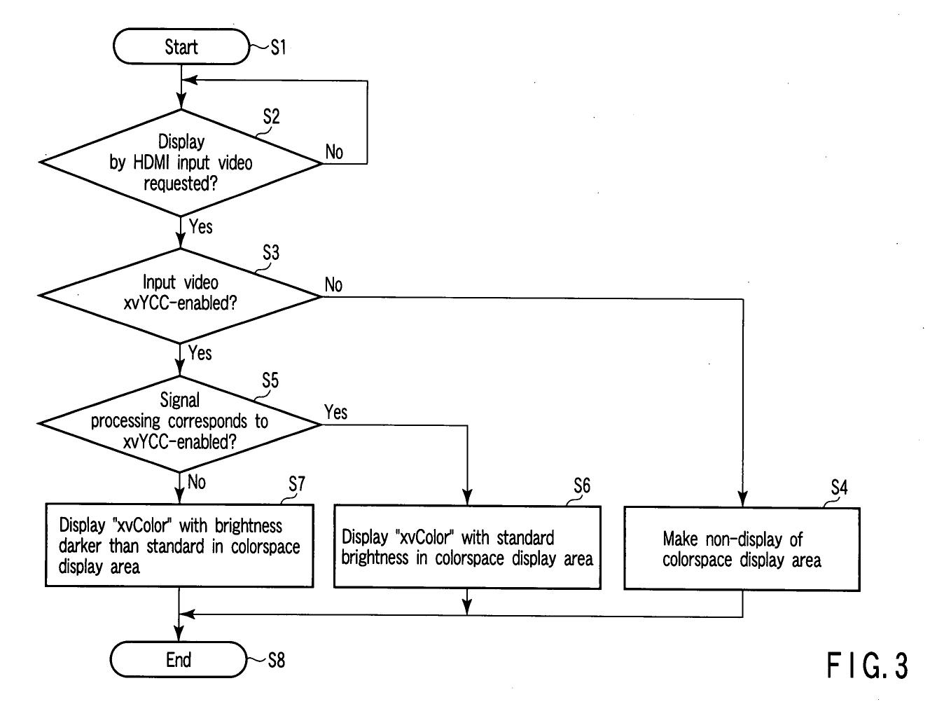

FIG. 3 is a flowchart to explain the processing operation by the controller 26. When processing is started (step S1), the controller 26 determines in step S2 whether or not a video display request by a digital video signal inputted to any of HDMI terminals 201 to 20n is made.

If it is determined that the video display request is made (YES), the controller 26 determines in step S3 whether or not the inputted digital video signal is an xvYCC-enabled signal. If it is determined that the digital video signal is not xvYCC-enabled (NO), the controller 26 makes control so that the colorspace display area 31c is set to a non-display state in step S4, and then, the controller 26 ends the procedure (step S8).

If it is determined that the inputted digital video signal in step S3 is xvYCC-enabled.(YES), the controller 26 determines in step S5 whether or not the signal processor 23 is set to a function of performing xvYCC-enabled signal processing. If it is determined that the signal processor 23 is set to the foregoing function (YES), in step S6, “xvColor” is displayed with standard brightness in the colorspace display area 31c, and then, the controller 25 ends the procedure (step S8).

If it is determined that the signal processor 23 is not set to a function of performing xvYCC-enabled signal processing (NO), the controller 26 displays “xvColor” with brightness darker than the standard in the colorspace display area 31c in step S7. Then, the controller 26 ends the procedure (step S8).

According to the foregoing embodiment, if the input digital video signal is xvYCC-enabled and the signal processor 23 corresponds to the standard colorspace, “xvColor” is displayed to the user with brightness darker than the standard in the colorspace display area 31c. However, the present invention is not limited to the foregoing embodiment. For example, luminance, color and size of the character “xv color” may be changed.

A dedicated state display icon indicative that the input digital video signal is xvYCC-enabled and the signal processor corresponds to the standard colorspace may be added. This may be displayed by changing a display format of the state display icon used for another function. A message that a preferable video is displayed by changing the signal processing function may be displayed on the video display unit 25.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
a receiver configured to receive a digital video signal transmitted in a format conforming to a specific digital signal transmission standard;
a signal processor configured to perform signal processing for video display with respect to a digital video signal received by the receiver, and to selectively switch signal processing corresponding to a standard colorspace and signal processing exceeding the standard colorspace; and
a display unit configured to display a message that a digital video signal received by the receiver corresponds to a colorspace exceeding the standard colorspace, and the signal processor is set to performing signal processing corresponding to the standard colorspace.

2. The apparatus according to claim 1, wherein the specific digital signal transmission standard is a high definition multimedia interface (HDMI) standard, and a colorspace exceeding the standard colorspace is an xvYCC-enabled colorspace.

3. The apparatus according to claim 1, wherein the display unit is configured to display a message that a digital video signal received by the receiver corresponds to a colorspace exceeding the standard colorspace, and the signal processor is set to a function of performing signal processing corresponding to the standard colorspace.

4. The apparatus according to claim 1, wherein the display unit is configured to display a specific character string with a standard brightness when a digital video signal received by the receiver corresponds to a colorspace exceeding the standard colorspace, and the signal processor is set to performing signal processing corresponding to the standard colorspace, and to display the specific character string with a brightness darker than a standard when a digital video signal received by the receiver corresponds to a colorspace exceeding the standard colorspace, and the signal processor is set to performing signal processing corresponding to the standard colorspace,

5. The apparatus according to claim 4, wherein the specific character string is xvColor.

6. A video signal processing method comprising:
receiving a digital video signal transmitted in a format conforming to a specific digital signal transmission standard;
supplying a received digital video signal to a signal processor selectively making a switch of signal processing corresponding to a standard colorspace and signal processing exceeding the standard colorspace to perform signal processing for video display; and
displaying a message that a received digital video signal corresponds to a colorspace exceeding the standard colorspace, and the signal processor is set to a function of performing signal processing corresponding to the standard colorspace.

7. A television broadcast receiver comprising:
a first receiver configured to receive a broadcast signal;
a first signal processor configured to perform signal processing for video display with respect to a video signal included in the broadcast signal received by the first receiver;
a second receiver configured to receive a digital video signal transmitted in a format conforming to a specific digital signal transmission standard;
a second signal processor configured to perform signal processing for video display with respect to a digital video signal received by the second receiver, and to selectively switch signal processing corresponding to a standard colorspace and signal processing exceeding the standard colorspace;
a selector configured to selectively output a video signal output from the first signal processor and a video signal output from the second signal processor; and
a display unit configured to display a message that a digital video signal received by the second receiver corresponds to a colorspace exceeding the standard colorspace, and the signal processor is set to performing signal processing corresponding to the standard colorspace.

8. The receiver according to claim 7, wherein the specific digital signal transmission standard is a high definition multimedia interface (HDMI) standard, and a colorspace exceeding the standard colorspace is an xvYCC-enabled colorspace.
